(19) United States
(12) Patent Application Publication
(10) Pub. No.: US 2026/0106439 A1
(43) Pub. Date: Apr. 16, 2026

(54) CONDUIT BODY FOR DIRECT ELECTRICAL CONDUIT CONNECTION

(71) Applicant: ABB SCHWEIZ AG, Baden (CH)

(72) Inventor: Daniel Edwards, Cordova, TN (US)

(21) Appl. No.: 18/913,808

(22) Filed: Oct. 11, 2024

(51) Int. Cl. H02G 3/08; H02G 3/04; H02G 3/06

(52) U.S. Cl. CPC H02G 3/088; H02G 3/0481; H02G 3/0641

(57) ABSTRACT

A conduit body including a connector port, a fastener member including a body and a cylindrical channel extending therethrough movably secured to the connector port, and a first seal member arranged in the cylindrical channel. The connector port being configured to form a liquid-tight connection with a liquid-tight flexible conduit by positioning the conduit to axially extend through the cylindrical channel and connecting an end of the flexible conduit to the connector port in the first channel. The first seal member being configured to elastically deform to fill a space between the fastener member, connector port, and flexible conduit, to retain the flexible conduit in the first channel. The conduit body can include a ground cone for connecting to the flexible conduit in the first channel, and a second seal member configured to elastically deform to fill an area between the flexible member and conduit body at the connector port.

### FIELD

The present disclosure relates to the field of electrical fittings. More particularly, to a conduit body for direct electrical conduit connection.

### BACKGROUND

Electrical conduits are utilized to install electrical components such as, for example, electrical conductors in locations including, but not limited to, manufacturing areas for pharmaceutical and food and beverage industries. In these manufacturing areas, electrical conduits are typically utilized because the elimination or reduction of contaminants or potential sources of contaminants of manufactured products and pharmaceuticals is of the highest priority. Accordingly, during production, product or intermittent cleaning solution may routinely escape a vicinity of production equipment and create a “splash-zone” within range of the electrical components. Moreover, production equipment and adjacent areas are routinely washed down by operators for sterilization purposes and to remove potentially harmful contaminants and other debris.

### SUMMARY

In some embodiments, a conduit device includes a connector port protruding from a conduit body, the connector port includes a first channel in fluid communication with an interior region of the conduit body; a fastener member includes a body and a cylindrical channel extending therethrough, the fastener member configured to engage the connector port to movably secure to the connector port; and a first seal member circumferentially arranged in the cylindrical channel of the fastener member; the connector port being configured to form a liquid-tight connection with a liquid-tight flexible conduit by positioning the liquid-tight flexible conduit so as to axially extend through the cylindrical channel of the body of the fastener member and connecting an end of the liquid-tight flexible conduit extending from the fastener member to the connector port in the first channel, and the first seal member being configured to fill a space between the fastener member, the connector port, and the liquid-tight flexible conduit, to retain the liquid-tight flexible conduit in the first channel in response to the fastener member engaging the connector port.

In some embodiments, the conduit device further includes a ground cone arranged in the first channel of the conduit body, the liquid-tight flexible conduit extending from the fastener member being connected to the connector port in the first channel includes the liquid-tight flexible conduit connecting to the ground cone in the first channel.

In some embodiments, the ground cone includes a first cylindrical portion including a flange configured to engage an end of the connector port; and a second cylindrical portion including a helical flange configured to engage the liquid-tight flexible conduit, and a second channel configured to be in fluid communication with the interior region of the conduit body in response to the ground cone being arranged in the first channel; and an inner diameter of the first cylindrical portion being greater than an outer diameter of the second cylindrical portion.

In some embodiments, the ground cone includes the first cylindrical portion continuously formed with the second cylindrical portion and defining a gap between an inner surface of the first cylindrical portion and an outer surface of the second cylindrical portion; and the liquid-tight flexible conduit is positioned in the gap between the first cylindrical portion and the second cylindrical portion when the helical flange of the ground cone engages a helical groove formed on an inner surface of the liquid-tight flexible conduit to connect the liquid-tight flexible conduit to the connector port.

In some embodiments, the connector port further includes a chamfer located between an inner surface and an outer surface of the connector port, the flange of the ground cone being configured to engage the connector port at the chamfer.

In some embodiments, the connector port further includes one or more threads formed on an outer surface of the connector port, and the fastener member further includes one or more threads formed on an inner surface of the cylindrical channel of the body adjacent a second end, the one or more threads of the fastener member configured to engage the one or more threads of the connector port to movably secure the fastener member to the connector port.

In some embodiments, the conduit device further includes a second seal member circumferentially arranged around the connector port, the second seal member fills a longitudinal area between the fastener member and the conduit body when the fastener member is connected to the connector port.

In some embodiments, the first seal member is formed of a first elastically deformable material; and the second seal member is formed of a second elastically deformable material.

In some embodiments, the first seal member and the second seal member are formed of a same elastically deformable material.

In some embodiments, the conduit body is a junction box configured to accommodate one or more electrical conductors.

In some embodiments, the conduit body is an outlet box configured to receive one or more electrical components includes an electrical outlet device and one or more electrical conductors.

In some embodiments, the conduit body includes a plurality of connector ports, at least one connector port of the plurality of connector ports includes the connector port.

In some embodiments, an apparatus includes a conduit body including one or more connector ports protruding from the conduit body in fluid communication with an interior region of the conduit body, at least one connector port of the one or more connector ports includes a liquid-tight connector port including a first channel, and one or more threads formed on an outer surface of the liquid-tight connector port; a gland nut including a body, a cylindrical channel extending through the body, and one or more threads formed on an inner surface of the cylindrical channel, the one or more threads of the cylindrical channel of the body being configured to engage the one or more threads of the liquid-tight connector port to movably secure the gland nut to the liquid-tight connector port; and a first seal member circumferentially arranged in the cylindrical channel of the gland nut, the first seal member formed of a first elastically deformable material; the liquid-tight connector port being configured to form a liquid-tight connection with a liquid-tight flexible conduit by positioning the liquid-tight flexible conduit so as to axially extend through the cylindrical channel of the body of the gland nut and connecting an end of the liquid-tight flexible conduit extending from the gland nut to the liquid-tight connector port in the first channel, and the first seal member filling a space between the gland nut, the liquid-tight connector port, and the liquid-tight flexible conduit, to retain the liquid-tight flexible conduit in the first channel in response to the gland nut engaging the liquid-tight connector port.

In some embodiments, the apparatus further includes a ground cone arranged in the first channel of the conduit body, the ground cone includes a first cylindrical portion including a flange configured to engage an end of the liquid-tight connector port; and a second cylindrical portion includes a helical flange configured to engage a helical groove formed on an inner surface of the liquid-tight flexible conduit, and a second channel configured to be in fluid communication with the interior region of the conduit body in response to the ground cone being arranged in the first channel; an inner diameter of the first cylindrical portion is greater than an outer diameter of the second cylindrical portion, and the first cylindrical portion being continuously formed with the second cylindrical portion and defining a gap between an inner surface of the first cylindrical portion and an outer surface of the second cylindrical portion; the liquid-tight flexible conduit extending from the gland nut being connected to the liquid-tight connector port in the first channel includes the liquid-tight flexible conduit being positioned in the gap between the first cylindrical portion and the second cylindrical portion when the helical groove engages the helical groove formed on an inner surface of the liquid-tight flexible conduit to connect the liquid-tight flexible conduit to the liquid-tight connector port.

In some embodiments, the liquid-tight connector port further includes a chamfer located between an inner surface and an outer surface of the liquid-tight connector port, the flange of the ground cone being configured to engage the liquid-tight connector port at the chamfer.

In some embodiments, the apparatus further includes a second seal member circumferentially arranged around the liquid-tight connector port, the second seal member formed of a second elastically deformable material, and the second seal member fills a longitudinal area between the gland nut and the conduit body when the gland nut is connected to the liquid-tight connector port.

In some embodiments, the first seal member and the second seal member are formed of a same elastically deformable material.

In some embodiments, the conduit body is a junction box configured to accommodate one or more electrical conductors.

In some embodiments, the conduit body is an outlet box configured to receive one or more electrical components includes an electrical outlet device and one or more electrical conductors.

In some embodiments, a method for assembling a conduit body, the method includes providing the conduit body includes a liquid-tight connector port protruding from the conduit body, the liquid-tight connector port defining a first channel in fluid communication with an interior region of the conduit body, and an outer surface of the liquid-tight connector port having one or more threads formed thereon; positioning a ground cone in the first channel of the liquid-tight connector port; arranging a first seal member in a fastener member, the fastener member includes a body includes a cylindrical channel extending therethrough, and an inner surface of the cylindrical channel of the body having one or more threads formed thereon; arranging a second seal member around the liquid-tight connector port; and movably securing the fastener member to the liquid-tight connector port.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a schematic diagram of an example apparatus, according to some embodiments.

FIG. 2 is a perspective view of an example apparatus of FIG. 1, according to some embodiments.

FIG. 3 is a sectional side view of the apparatus of FIG. 2, according to some embodiments.

FIG. 4 is an exploded view of the apparatus of FIG. 2, according to some embodiments.

FIG. 5 is a perspective view of an example apparatus of FIG. 1, according to some embodiments.

FIG. 6 is a sectional side view of the apparatus of FIG. 5, according to some embodiments.

FIG. 7 is an exploded view of the apparatus of FIG. 5, according to some embodiments.

FIG. 8 is a flow diagram of a method for assembling a conduit body of FIG. 1, according to some embodiments.

### DETAILED DESCRIPTION

Electrical systems are commonly utilized in commercial and residential applications to supply electrical power from a power source to one or more electrical devices or to place electrical devices in electronic communication with other electronic devices. Electrical systems include components such as, for example, conduits, conduit bodies, receptacles, electrical distribution panels, and the like, that can be connected to form enclosed pathways, or raceways, for wiring electrical conductor between one or more locations through the electrical system. For example, one or more segments of conduit can be connected in series between a power source and an electrical receptacle for wiring electrical conductor through the connected segments of conduit to electrically connect a power source to an electrical receptacle for supplying electrical power from the power source to the electrical receptacle and electrical devices connected to the electrical receptacle.

Electrical conduits can include rigid conduits and flexible conduits. For rigid conduits, a terminal end of the rigid conduit can be threaded (e.g., tapered threads) on the outer surface so the rigid conduit can be connected to other components such as, for example, a conduit body having a corresponding connector port for connecting to rigid conduit. For example, the rigid conduit can be connected to a connector port on a conduit body by threading the terminal end of the rigid conduit into the connector port, the connector port having a corresponding threaded inner surface formed thereon. In another example, a segment of rigid conduit can be connected to another segment of rigid conduit using an electrical fitting, each end of the electrical fitting having a threaded inner surface corresponding to the threaded outer surface at the respective ends of the rigid conduit so as to enable a terminal end of the respective rigid conduit to be attached to the electrical fitting.

Flexible conduit can include flexible metallic conduit, liquid-tight flexible metallic conduit, liquid-tight flexible non-metallic conduit, and flexible tubing. Flexible conduit can be utilized in locations where space is limited or where the available dimensions prevent installing rigid conduits. For example, flexible conduits can be utilized between components that are less than a certain distance apart. Flexible conduit can be formed, for example, by coiling up an elongate segment of metal and interlocking the rings together so that the outer and inner surface of the electrical conduit forms a helical groove radially extending along a longitudinal length of the electrical conduit at an inner surface of the flexible conduit, an outer surface of the flexible conduit, or both an inner surface and an outer surface of the flexible conduit. It is to be appreciated that the flexible conduit can be formed using one or more different methods and is not intended to be limiting.

Liquid-tight flexible conduit can be connected to other raceway components such as a conduit body or another conduit. However, connector ports on conduit bodies are typically configured to connect to rigid conduits and not to flexible conduit. Accordingly, to connect a flexible conduit to a connector port on a conduit body, components including a liquid-tight connector fitting, ground cone, gland nut, and seal member(s), are utilized. For example, to connect a flexible conduit to a conduit body having a connector port configured to connecting to a rigid conduit, a terminal end of the flexible conduit is connected to a ground cone located in at one end of an electrical connector fitting, a gland nut fixedly connects the flexible connector to the end of the electrical connector fitting by engaging the electrical connector fitting, and the other end of the connector fitting is connected to the connector port by threading a threaded outer surface of the connector fitting into a corresponding threaded inner surface of the connector port. In this regard, connecting the flexible conduit to the conduit body requires an electrical connector fitting that connects to the flexible conduit at one end of the connector fitting and connects to the connector port of the conduit body at the other end of the connector fitting. In another example, the connector port on the conduit body can be an NPT threaded connector port and an electrical connector fitting having a corresponding end configured to connect to the NPT threaded connector port can be used to connect a flexible conduit to the conduit body.

Liquid-tight conduits and fittings are utilized in manufacturing areas for pharmaceutical and food and beverage industries where the elimination or reduction of contaminants or potential sources of contaminants of manufactured products and pharmaceuticals is of the highest priority. During production, product or intermittent cleaning solution may routinely escape a vicinity of production equipment and create a “splash-zone” within range of electrical fittings. Moreover, production equipment and adjacent areas are routinely washed down by operators for sterilization purposes and to remove potentially harmful contaminants and other debris. In these areas, liquid-tight conduits and liquid-tight connector fittings can be utilized to prevent liquid such as, for example, water, manufacturing product, and cleaning solution from entering the conduit and damaging the electrical conductors located in the conduit and associated established electrical connections formed by the electrical conductors.

Liquid-tight flexible metallic conduit (“LFMC”) is a type of flexible conduit which surrounds an electrical conductor and is configured to be waterproof and configured to form liquid-tight connections when connected to other electrical components using liquid-tight electrical connector fittings so as to prevent liquid from entering the conduit. In addition, the LFMC can include a jacket that surrounds an outer surface of the LFMC to provide the interior of the LFMC protection from liquids. In certain areas, the electrical system can include LFMC and liquid-tight electrical fittings so as to prevent the intrusion of liquid into the conduit.

Various embodiments of the present disclosure relate to devices, apparatuses, and methods of assembling a conduit body apparatus including a connector port capable of directly connecting to a flexible electrical conduit for wiring electrical conductors or other electrical components between the conduit and the conduit body. The connector port on the conduit body can be connected to the flexible electrical conduit without utilizing an electrical connector fitting that connects to the flexible conduit at one end of the fitting and connects to the connector port at the other end of the fitting to connect the flexible conduit to the conduit body. In addition, the connector port can form a liquid-tight connection with the flexible electrical conduit to prevent intrusion of liquid such as, for example, water into the interior raceway space through the connection point. In some embodiments, the flexible electrical conduit can be a liquid-tight flexible electrical conduit. In other embodiments, the flexible electrical conduit can be a liquid-tight flexible metallic electrical conduit.

By providing a conduit body that includes a connector port that can be directly connected to flexible conduit without utilizing an electrical connector fitting, the number of components needed for connecting the flexible conduit to the conduit body is reduced along with the number of materials associated with manufacturing the connector fitting. Furthermore, by providing a conduit body that can directly connect to the flexible conduit removes the additional step(s) of connecting the flexible conduit to the electrical connector fitting and connecting the electrical connector fitting to the connector port on the conduit body, which improves ease of user operation and reduces a likelihood of user error. For example, the user can lose the connector fitting during installation, which prevents the user from connecting the flexible conduit to the conduit body until a replacement connector fitting is installed. The electrical conduit, the connector port, or the electrical fitting can also become damaged as a result of, for example, applying an excessive amount of torque to the component during installation. Moreover, by enabling the flexible conduit to be directly installed onto the connector port without utilizing the electrical connector fitting, the size of the connection is reduced, which provides an improvement over other types of conduit bodies that utilize an electrical connector fitting to connect the flexible conduit when installing the components in locations with limited available space.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

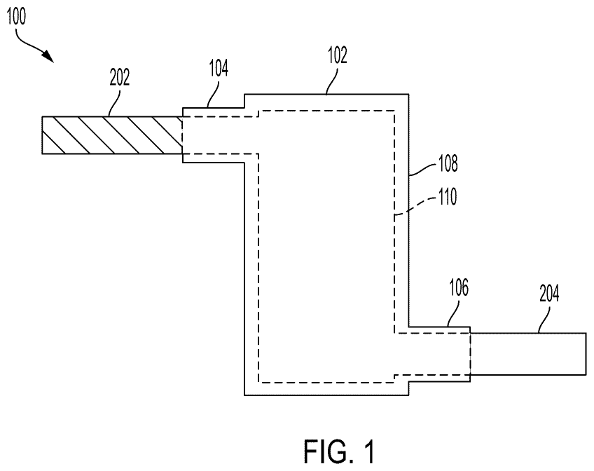

FIG. 1 is a schematic diagram illustrating an example apparatus 100 for use as a liquid-tight conduit body 102 in splash-zone and wash-down environments, according to some embodiments.

Apparatus 100 includes a liquid-tight conduit body 102. Liquid-tight conduit body 102 can be referred to herein as conduit body 102. Conduit body 102 can be utilized in an electrical system (not shown) to form a raceway for wiring electrical conductors through the electrical system. To form the raceway, the conduit body 102 can include one or more connector ports that can be connected to respective electrical conduits and the electrical conductors can be directed through the interior region defined by the electrical conduits and the conduit body 102.

Conduit body 102 can include one or more connector ports formed from conduit body 102. At conduit body 102, the one or more connector ports can include connector port 104. Connector port 104 can be configured to connect to electrical conduit 202. In some embodiments, connector port 104 can be a liquid-tight connector port configured to form a liquid-tight connection to electrical conduit 202.

In some embodiments, the one or more connector ports can further include other connector ports such as, for example, connector port 106. That is, in some embodiments, conduit body 102 can include one or more connector ports, and the one or more connector ports can include at least one connector port 104. The other connector ports of the one or more connector ports can include connector port 104, connector port 106, or any combination thereof. It is to be appreciated that connector port 106 is exemplary and not intended to be limiting. Accordingly, connector port 106 can include any of a plurality of different types of connector ports configured to connect to any of a plurality of different types of electrical conduits such as, for example, flexible conduit, rigid conduit, or other types of conduits.

According to some embodiments, conduit body 102 can include one connector port, two connector ports, three connector ports, four connector ports, or four or more connector ports. In some embodiments, conduit body 102 can include a plurality of connector ports, and at least one of the connector ports can be connector port 104. Referring to FIG. 1, conduit body 102 is shown including connector port 104 and connector port 106. It is to be appreciated that conduit body 102 as shown in the figures is not intended to be limiting and can include any number of connector ports and be arranged in any type of configuration as can be appreciated by those skilled in the art. Additionally, it is to be appreciated that conduit body 102 can include any of a plurality of sizes, shapes, and dimensions for connecting to electrical conduits and for accommodating electrical components therein in accordance with the present disclosure.

Electrical conduit 202 can be an elongate cylindrical member defining an inner channel for directing electrical wiring therethrough. In some embodiments, electrical conduit 202 can be a flexible conduit. In other embodiments, electrical conduit 202 can be a liquid-tight flexible conduit. In some embodiments, electrical conduit 202 can be a liquid-tight flexible metallic conduit.

According to some embodiments, connector port 104 can be configured to connect to liquid-tight flexible conduits. That is, rigid conduit cannot be connected to connector port 104 without using, for example, an electrical connector fitting adapted to connect the rigid conduit to connector port 104. In some embodiments, electrical conduit 202 does not include rigid conduits.

Connector port 106 can be configured to connect to electrical conduit 204. In some embodiments, the electrical conduit 204 can be a rigid conduit. In other embodiments, the electrical conduit 204 can be a flexible conduit similar to electrical conduit 202.

Conduit body 102 can include one or more sidewalls 108. The one or more sidewalls 108 of conduit body 102 can define an interior region 110. The interior region 110 of conduit body 102 can be in fluid communication with one or more of the connector ports 104, 106. In some embodiments, the interior region 110 can be in fluid communication with connector port 104. In other embodiments, the interior region 110 can be in fluid communication with connector port 106. In some embodiments, the interior region 110 can be in fluid communication with connector port 104 and one or more other connector ports of the conduit body 102 such as, for example, connector port 106.

The interior region 110 of conduit body 102 can accommodate or house one or more electrical components. For example, the interior region 110 of the conduit body 102 can house one or more electrical conductors extending into the conduit body 102 through the one or more connector ports and electrical conduits, the one or more electrical conductors being electrically connected with one or more other respective electrical components at other areas of the electrical system. In some embodiments, conduit body 102 can be a junction box, and conduit body 102 can accommodate one or more electrical conductors. In other embodiments, conduit body 102 can be an outlet box, and conduit body 102 can accommodate one or more electrical components including, for example, an electrical outlet and one or more electrical conductors connected to the electrical outlet.

The conduit body 102 can be made of a metallic material so as to enable providing the conduit body 102 with a grounding connection and to enable the conduit body 102 to provide grounding protection to one or more other components including, for example, electrical conductors, electrical conduits connected to conduit body 102, other electrical components installed in conduit body 102, or any combination thereof. The metallic material can include, but is not limited to, iron, aluminum, stainless steel, or any combination thereof. In some embodiments, the conduit body 102 can be made of cast iron. For example, the conduit body 102 can be sand cast out of iron. In other embodiments, the conduit body 102 can be made of aluminum. For example, the conduit body 102 can be made of cast aluminum. In yet other embodiments, the conduit body 102 can be made of stainless steel.

It is to be appreciated that the materials used to form the conduit body 102 is not intended to be limiting and can include iron, aluminum, stainless steel, or can include other types of metallic materials. In some embodiments, the conduit body 102 can include at least one of iron, aluminum, or stainless steel. In other embodiments, the conduit body 102 can include at least one of iron, aluminum, or stainless steel, and the conduit body 102 can further include one or more other metallic materials. In some embodiments, the other types of metallic materials can be electrically conductive metallic materials.

In some embodiments, the conduit body 102 can be made of a plastic material. The conduit body 102 can be formed of plastic material having a rigid structure suitable for utilizing the conduit body 102 as a raceway and for connecting the electrical conduit 202, electrical conduit 204, or both, to the conduit body 102. For example, the conduit body 102 can be made of polyvinyl chloride.

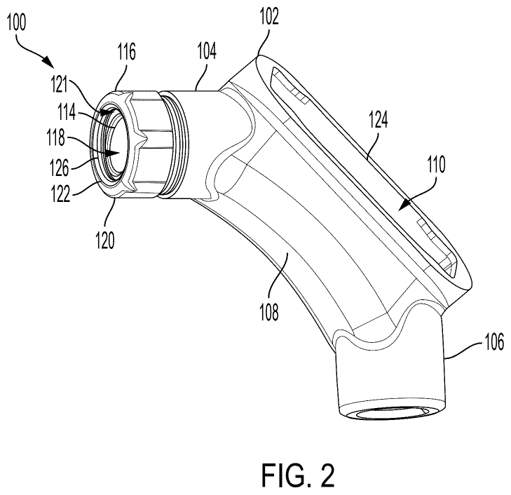

It is to be appreciated that conduit body 102 can include any of a plurality of different configurations and is not intended to be limited to one configuration. For example, the configuration of conduit body 102 can include, but is not limited to, straight body, angled body, LR, LL, LB, T-shaped, C-shaped, X-shaped, other configurations, or any combination thereof, in accordance with the present disclosure. For example, in FIG. 2, the conduit body 102 is shown having an angled body configuration. However, it is to be appreciated that conduit body 102 can include other configurations in accordance with the present disclosure.

FIG. 2 is a perspective view of the apparatus 100 of FIG. 1, according to some embodiments.

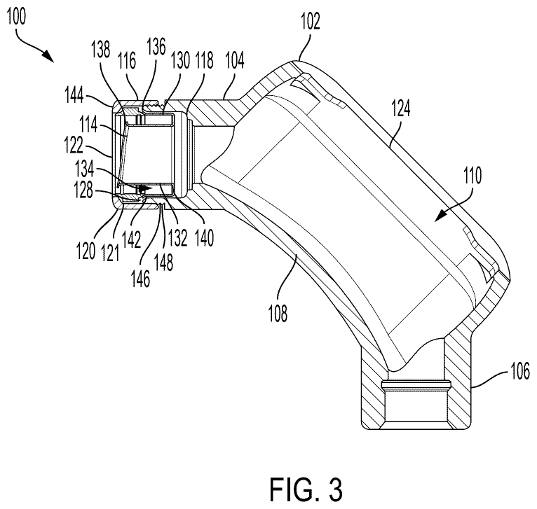

Apparatus 100 includes conduit body 102, ground cone 114, and fastener member 116. Conduit body 102 can include one or more connector ports including connector port 104. Connector port 104 includes a first channel 118 in fluid communication with the interior region 110 of conduit body 102, as shown in FIGS. 1 and 3.

Ground cone 114 can be arranged in first channel 118 of connector port 104 and fastener member 116 can be movably secured to an end of connector port 104 opposite connector port 104.

Fastener member 116 can include a body 120 including a first end and a second end opposite the first end, the body 120 can include an inner channel 121 extending through the body 120 from the first end to the second end. In some embodiments, the inner channel 121 can be an inner cylindrical channel extending through the body 120. In addition, the body 120 can include a unique outer profile formed thereon. The unique outer profile of the body 120 can facilitate installation of the fastener member 116 onto the connector port 104 by a user. For example, the unique outer profile of the body 120 enables the fastener member 116 to be installed onto the connector port 104 by a user using a hand tool such as a wrench.

The outer profile of the body 120 can include at least one side. In some embodiments, the outer profile of the body 120 an include two, three, four, five, six, or more sides. For example, in some embodiments, the outer profile of the body 120 can include a hexagonally shape and an inner cylindrical channel can extend through the body 120. In other embodiments, the outer profile of the body 120 can be formed by one or more protrusions formed on an outer surface of the body 120. For example, the one or more protrusions can extend in an axial direction from the first end of body 120 to the second end of body 120 on the outer surface. In some embodiments, at least a portion of the outer surface of the body 120 of fastener member 116 can include the unique profile. For example, a portion of the outer surface of the body 120 adjacent the first end can include a hexagonal shape. In this regard, the rest of the outer surface of the body 120 of fastener member 116 can include any of a plurality of other shapes. For example, the rest of the outer surface of the body 120 of fastener member 116 can include a cylindrical shape adjacent the second end. In other embodiments, the unique outer profile of the body 120 of fastener member 116 can extend from the first end to the second end. It is to be appreciated that the size, shape, and dimension of the body 120 of fastener member 116 is not intended to be limiting and can include any of a plurality of different shapes, sizes, and dimensions suitable for connecting to the connector port 104 of conduit body 102.

When connecting an electrical conduit 202 to connector port 104, the electrical conduit 202 can be positioned so as to axially extend through the inner channel of body 120 by inserting the electrical conduit 202 into the first end of body 120 and out the second end of body 120. In addition, the body 120 of fastener member 116 can be suitably sized so as to accommodate electrical conduit 202 extending therethrough and so as to enable the electrical conduit 202 to be connected to the ground cone 114, connector port 104, or both. In some embodiments, fastener member 116 can be a gland nut.

The body 120 of fastener member 116 can include a cap portion 144 (FIG. 3) and an aperture 122 located at the first end of the body 120. In some embodiments, cap portion 144 can include aperture 122 defined by a circumferential opening formed at an end of cap portion 144. In this regard, the inner channel of body 120 can be a first diameter and the aperture 122 of body 120 can be a second diameter, the first diameter of the body 120 can be greater than the second diameter of the aperture 122. Aperture 122 can include the second diameter, the second diameter having a suitable size to enable electrical conduit 202 to extend through aperture 122. The inner channel of the body 120 can include the first diameter, the first diameter having a suitable size that is greater than the second diameter of aperture 122 to enable the fastener member 116 to retain the first seal member 126 in the inner channel of body 120 with the electrical conduit 202 extending through the body 120 and the first seal member 126, and so that the first seal member 126 can engage the ground cone 114 and form a sealed connection point when connecting the fastener member 116 to connector port 104. In addition, the first diameter of the body 120 can include a suitable size so as to enable the inner surface of body 120 to engage an outer surface of connector port 104 to connect fastener member 116 to connector port 104 and to form a sealed connection between the electrical conduit 202 and the conduit body 102 at the connector port 104.

Fastener member 116 can be configured to receive electrical conduit 202 so that the electrical conduit 202 extends through the inner channel of body 120 and the electrical conduit 202 can be connected to connector port 104. Aperture 122 can include a suitable size and diameter to enable electrical conduit 202 to extend through aperture 122. Body 120 can also include a suitable size and diameter to enable electrical conduit 202 to extend through body 120. In some embodiments, the diameter of body 120 can be greater than a diameter of aperture 122. In other embodiments, electrical conduit 202 can include a helical groove formed on an outer surface, and aperture 122 can include a suitable size and diameter to engage an outer surface of electrical conduit 202 when positioning electrical conduit 202 through aperture 122 so that electrical conduit 202 can be positioned so as to extend through fastener member 116 and connected to connector port 104. The aperture 122 can be configured, in some embodiments, to engage electrical conduit 202 when positioning electrical conduit 202 through the body 120 of fastener member 116 to retain the position of electrical conduit 202 relative to fastener member 116 and to facilitate connecting the electrical conduit 202 to connector port 104 or connecting the electrical conduit 202 to the ground cone 114 in the connector port 104.

Connecting electrical conduit 202 to connector port 104 can include fastener member 116 engaging the connector port 104 so as to movably connect fastener member 116 to connector port 104. Connecting electrical conduit 202 to connector port 104 can include positioning electrical conduit 202 so as to extend through fastener member 116. Positioning electrical conduit 202 to extend through fastener member 116 can include extending electrical conduit 202 through aperture 122 at the first end of fastener member 116, extending electrical conduit 202 through first seal member 126 located adjacent the first end of fastener member 116, extending electrical conduit 202 through the body 120 of fastener member 116, and extending electrical conduit 202 out from the second end of fastener member 116. Connecting electrical conduit 202 to connector port 104 can include positioning electrical conduit 202 so as to engage ground cone 114 in the first channel 118 of connector port 104. Moreover, fastener member 116 engaging the connector port 104 so as to movably connect fastener member 116 to connector port 104 can include the first seal member 126 located in fastener member 116 engaging the ground cone 114 and forming the sealed connection at connector port 104 between electrical conduit 202 and conduit body 102 at connector port 104.

It is to be appreciated that the connector port 104, ground cone 114, and fastener member 116 are not intended to be limiting, and the connector port 104, ground cone 114, and fastener member 116 can instead include any of a plurality of suitable sizes, shapes, or dimensions to enable connecting electrical conduit 202 to connector port 104 in accordance with the present disclosure. For example, connector port 104 can include a first channel 118 having a suitable size so as to receive ground cone 114 in the first channel 118 and for electrical conduit 202 to connect to the ground cone 114 in the first channel 118, and ground cone 114 can have a suitable size so as to engage a surface of connector port 104 and to connect to electrical conduit 202. In another example, fastener member 116 can have a suitable size so that electrical conduit 202 can extend through aperture 122 and body 120 and to enable fastener member 116 to movably connect to connector port 104 by an inner surface of body 120 engaging the outer surface of connector port 104.

Conduit body 102 can include an aperture 124 defining an opening placing the interior region 110 in fluid communication with an exterior region of conduit body 102. The aperture 124 can be defined by the one or more sidewalls 108 of conduit body 102. In this regard, a user can access the interior region 110 through aperture 124 such as, for example, when wiring an electrical conductor received from electrical conduit 202 into the interior region 110. It is to be appreciated that the shape and dimensions of aperture 124 are not intended to be limiting, and the opening of aperture 124 can include any of a plurality of shapes having any of a plurality of different dimensions.

Although not shown, apparatus 100 can further include a cover plate. The cover plate can be configured to cover the aperture 124. In this regard, the cover plate can include suitable dimensions for covering at least the aperture 124. The cover plate can also be configured to be connected to the conduit body 102 using, for example, one or more fastener elements. In addition, the one or more fastener elements that connect the cover plate to the conduit body 102 can include, but is not limited to, screws, clips, rivets, bolts, nuts, clamps, other like fastener elements, or any combinations thereof. Although not shown, the apparatus 100 can further include a gasket. The gasket can be arranged between the conduit body 102 and the cover plate to provide a liquid-tight seal when the cover plate is attached to the conduit body 102 using the fastener elements. In some embodiments, the conduit body 102 can include a groove formed around at least a portion of the aperture 124, and the gasket can be arranged in the groove so the gasket surrounds the aperture 124 and can provide a liquid-tight seal when the cover plate is attached to the conduit body 102 using the fastener elements.

It is to be appreciated that the shape and dimensions of conduit body, connector port, ground cone, fastener, first sealing member, second sealing member, and other components described herein are not intended to be limiting unless stated otherwise. Instead, the shape and dimensions of these components can depend on the particular application. In this regard, for example, a diameter of the electrical conduit can be dependent on the number and size of the electrical conductors extending therethrough, dimensions of the conduit body can be dependent on the electrical components housed therein, dimensions of the connector port can be dependent on the dimensions of the electrical conduit (or the number and size of the electrical components extending therethrough), dimensions of the ground cone and the fastener can be dependent on the dimensions of the electrical conduit and the dimensions of the connector port, dimensions of the first sealing member can be dependent on the dimensions of the fastener and the electrical conduit, dimensions of the second sealing member can be dependent on the dimensions of the connector port, or any combination thereof.

It is to be appreciated that the conduit body can include any of a plurality of configuration and is not intended to be limiting. In this regard, the conduit body configuration can include, but is not limited to, straight body, angled body, LR, LL, LB, T-shaped, C-shaped, X-shaped, and other configurations. In addition, the dimensions of the conduit body is not intended to be limiting. For example, the conduit body can include appropriate dimensions for installing an electrical device into the receptacle such as, for example, an electrical plug receptacle. Furthermore, number and type of connector ports protruding from the conduit body is not intended to be limiting so long as at least one of the connector ports corresponds to the connector port of the present disclosure for connecting the flexible conduit to the conduit body. For example, the conduit body can include one, two, three, four, or more connector bodies extending from the conduit body.

FIG. 3 is a sectional side view of the apparatus 100 of FIG. 2, according to some embodiments.

Apparatus 100 includes conduit body 102 including connector port 104. In some embodiments, the conduit body 102 includes one or more connector ports. In some embodiments, the conduit body 102 forms the one or more connector ports. In some embodiments, the conduit body 102 forms connector port 104. That is, connector port 104 protrudes from the conduit body 102 and defines a first channel 118 in fluid communication with the interior region 110 of the conduit body 102. In other embodiments, the conduit body 102 forms connector port 104 and connector port 106. That is, connector port 104 and connector port 106 can protrude from the conduit body 102.

In some embodiments, the first channel 118 can be configured to accommodate an electrical conductor (not shown) that can extend through electrical conduit 202 and can terminate at conduit body 102 or can extend through conduit body 102 to another electrical conduit such as, for example, electrical conduit 204. In some embodiments, conduit body 102 can be an outlet box and the interior region 110 of conduit body 102 can be configured to receive an electrical outlet device.

Apparatus 100 includes ground cone 114. Ground cone 114 can be arranged in the first channel 118 of connector port 104. When positioned in first channel 118, ground cone 114 can engage a surface 128 of connector port 104 so as to provide the ground cone 114 with grounding protection. In this regard, when the apparatus 100 is installed in, for example, a manufacturing facility, conduit body 102 can be electrically grounded through the grounding connection so that the ground cone 114 installed in the first channel 118 and engaging a surface of the conduit body 102 at the connector port 104 is also electrically grounded through the grounding connection of the conduit body 102. In addition, when electrical conduit 202 is connected to ground cone 114, and the ground cone 114 is installed into the first channel 118 of connector port 104, the electrical conduit 202 can also be electrically grounded through the grounding connection of conduit body 102 via ground cone 114.

A liquid-tight connection between the electrical conduit 202 and the connector port 104 of conduit body 102 can be formed by positioning the electrical conduit 202 so as to axially extend through fastener member 116 and positioning the electrical conduit 202 so as to axially extend through the first seal member 126 arranged adjacent the first end of the fastener member 116. The end of the electrical conduit 202 extending from the second end of the fastener member 116 can then be connected to connector port 104. In some embodiments, the end of the electrical conduit 202 extending from the second end of the fastener member 116 can then be connected to connector port 104 by connecting the end of the electrical conduit 202 to the ground cone 114 in the first channel 118. In addition, the connector port 104 can be configured to form the liquid-tight connection between the electrical conduit 202 and the conduit body 102 by the fastener member 116 engaging the connector port 104 such that the first seal member 126 engages the portion of the ground cone 114 surrounding the electrical conduit 202 to retain the ground cone 114 in the first channel 118 of connector port 104 and the first seal member 126 elastically deforms to fill the space of the connection point and to form the liquid-tight connection between electrical conduit 202 and the connector port 104. The space of the connection point can include ground cone 114, fastener member 116, connector port 104, electrical conduit 202, or any combination thereof. In some embodiments, the space of the connection point can include fastener member 116, connector port 104, and electrical conduit 202. In other embodiments, the space of the connection point can include ground cone 114, fastener member 116, connector port 104, and electrical conduit 202.

The ground cone 114 can include a first cylindrical portion 130 and a second cylindrical portion 132. In some embodiments, the first cylindrical portion 130 and the second cylindrical portion 132 can be continuously formed together to form the ground cone 114. In addition, in some embodiments, the first cylindrical portion 130 can be in colinear alignment with the second cylindrical portion 132.

First cylindrical portion 130 can include a first inner diameter and a first outer diameter. The first outer diameter of first cylindrical portion 130 can be suitably sized to enable arranging ground cone 114 in the first channel 118 of connector port 104. In some embodiments, the first seal member 126 can be configured to engage an end of the first cylindrical portion 130 to retain the ground cone 114 in the first channel 118 of the connector port 104.

Second cylindrical portion 132 can include a second inner diameter and a second outer diameter. The first inner diameter of first cylindrical portion 130 can be greater than the second outer diameter of second cylindrical portion 132. The first inner diameter of first cylindrical portion 130 can be greater than the second outer diameter of second cylindrical portion 132 such that when ground cone 114 engages electrical conduit 202 and connects thereto, ground cone 114 can receive an end of electrical conduit 202 at a circumferentially spaced gap forming a receptacle 134 between the inner diameter of first cylindrical portion 130 and the outer diameter of second cylindrical portion 132. In this regard, when connecting the electrical conduit 202 to ground cone 114, the end of the electrical conduit 202 is inserted into the receptacle 134 formed between the first cylindrical portion 130 and the second cylindrical portion 132 as the ground cone 114 engages the inner surface of electrical conduit 202.

The first cylindrical portion 130 can include a flange 136. The flange 136 can be formed at a circumferential end of first cylindrical portion 130, the flange 136 can radially extend outward from the circumferential end of first cylindrical portion 130. In some embodiments, the flange 136 can be configured to engage the surface 128 at the end of the connector port 104 to provide the ground cone 114 with a grounding connection through the conduit body 102 and connector port 104. That is, the flange 136 can include suitable dimensions for engaging the surface of connector port 104 and placing the ground cone 114 in mechanical and electrical connection with connector port 104. In some embodiments, an outer circumferential diameter of flange 136 can be greater than the first outer diameter of the first cylindrical portion 130 and an inner diameter of the first channel 118 of connector port 104. In addition, the first outer diameter of first cylindrical portion 130 can be less than an outer diameter of connector port 104.

The second cylindrical portion 132 can have a second outer diameter suitable for connecting to electrical conduit 202. The second cylindrical portion 132 can include a helical flange 138. The helical flange 138 can be formed at a circumferential end of the second cylindrical portion 132 opposite the first cylindrical portion 130 and flange 136. Helical flange 138 can extend radially outward from the circumferential end of the second cylindrical portion 132 such an outer diameter of helical flange 138 is greater than the second outer diameter of second cylindrical portion 132. The helical flange 138 can be configured to engage the electrical conduit 202. That is, the electrical conduit 202 can be formed so as to include a helical groove on the inner surface of electrical conduit 202, and the helical flange 138 can engage the helical groove formed on the inner surface of electrical conduit 202 to connect the electrical conduit 202 to ground cone 114. In addition, the second cylindrical portion 132 of ground cone 114 can define a second channel 140. When ground cone 114 is installed into the first channel 118 of connector port 104, the second channel 140 can be in fluid communication with the first channel 118 of connector port 104 or the interior region 110 of conduit body 102. In this regard, when electrical conduit 202 is connected to ground cone 114 in the first channel 118 of connector port 104, the electrical conduit 202 can be placed in fluid communication with the first channel 118 of connector port 104 and the interior region 110 of conduit body 102.

In some embodiments, connector port 104 can further include a chamfer 142. Chamfer 142 can be located at surface 128 of connector port 104 adjacent the end of the connector port 104. In some embodiments, chamfer 142 can be located between the inner surface of first channel 118 and an exterior surface of connector port 104. In some embodiments, flange 136 of the first cylindrical portion 130 of ground cone 114 can be configured to engage the surface 128 of the chamfer 142 of connector port 104 so as to provide the ground cone 114 with the ground connection. As such, when electrical conduit 202 is connected to ground cone 114, the flange 136 of ground cone 114 engaging the surface 128 of chamfer 142 also provides electrical conduit 202 with the ground protection.

Apparatus 100 includes fastener member 116. Fastener member 116 can be configured to engage connector port 104 to movably secure fastener member 116 to connector port 104. Fastener member 116 can include a cap portion 144 and a threads 146. The cap portion 144 can be formed at the first end of the body 120 of fastener member 116 opposite the second end that engages the connector port 104. The cap portion 144 of body 120 can project in a radially inward direction toward a longitudinal axis of fastener member 116 and forms the aperture 122. Aperture 122 can include a size and diameter that is less than a size and diameter of body 120 to enable positioning electrical conduit 202 through fastener member 116 from the first end to the second end to enable an end of the electrical conduit 202 to connect to ground cone 114 in first channel 118 of connector port 104, to enable first seal member 126 to be arranged in the body 120 of fastener member 116 adjacent the first end, and to enable fastener member 116 to connect to connector port 104 by the inner surface of body 120 movably engaging the outer surface of connector port 104.

In some embodiments, fastener member 116 can include threads 146 formed at an inner surface of the body 120 at the second end, and connector port 104 can include threads 148 formed at an outer surface of connector port 104, the threads 148 corresponding to threads 146 to enable fastener member 116 to movably engage connector port 104. Threads 146 of fastener member 116 can engage threads 148 of connector port 104 to connect fastener member 116 to connector port 104.

Apparatus 100 includes a first seal member 126. First seal member 126 can be formed of a first elastically deformable material. First seal member 126 can be arranged in body 120 of fastener member 116 adjacent the first end. In some embodiments, first seal member 126 can be arranged in body 120 adjacent to cap portion 144 near the first end. When fastener member 116 is movably secured to connector port 104, the first seal member 126 can be arranged in a space between the end of the connector port 104 and the cap portion 144 of body 120. In some embodiments, the space can also be defined by ground cone 114. In this regard, when installing electrical conduit 202 onto ground cone 114 using fastener member 116, fastener member 116 can be connected to connector port 104, and the first seal member 126 arranged at the inner surface of body 120 can be configured to elastically deform in response to the fastener member 116 engaging the connector port 104 so as to form a liquid-tight seal at the connection point. The connection point can be between the electrical conduit 202 and the connector port 104. In some embodiments, the connection point can be between electrical conduit 202 and ground cone 114. In other embodiments, the connection point can be between electrical conduit 202, ground cone 114, and fastener member 116. In some embodiments, the connection point can be between electrical conduit 202, ground cone 114, fastener member 116, connector port 104, or any combination thereof.

The flexible properties of the first seal member 126 can allow the first seal member 126 to compressively fill a space between connector port 104 and an interior surface of the fastener member 116 when the fastener member 116 is secured to connector port 104 with the electrical conduit 202 connected to the ground cone 114. In addition, the compressive seal formed by first seal member 126 by the fastener member 116 engaging the connector port 104 can prevent an ingress of contaminants such as, for example, liquid from production equipment or a wash-down operation, into the interior spaces of the raceway of conduit body 102, electrical conduit 202, or any portions thereof. As a result of the compressive seal formed by the first seal member 126, the liquid-tight connection between the connector port 104 and the electrical conduit 202 may be suitable for use as a hygienic liquid-tight fitting in splash-zone and wash-down environments.

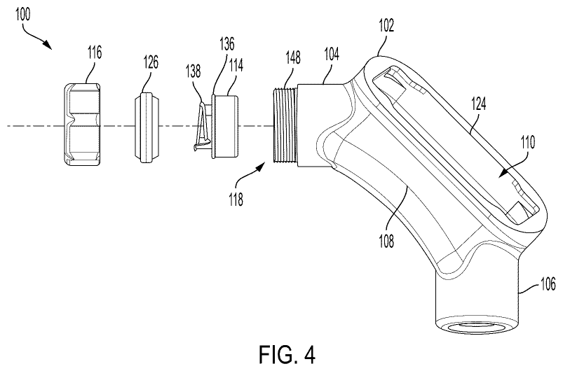

FIG. 4 is an exploded view of the apparatus 100 of FIG. 2, according to some embodiments.

Apparatus 100 can come pre-assembled including conduit body 102 having at least connector port 104, ground cone 114 arranged in first channel 118 of connector port 104, first seal member 126 arranged in the body 120 of fastener member 116 adjacent the cap portion 144, and the fastener member 116 movably engaging an end of the connector port 104.

The ground cone 114 can be positioned in first channel 118 so that the flange 136 engages the surface 128 at the end of the connector port 104. In addition, the fastener member 116 can include a threads 146 at body 120 corresponding to the threads 148 of the connector port 104, and the threads 146 of the fastener member 116 can engage the threads 148 of the connector port 104 to movably connect the fastener member 116 to the connector port 104.

Furthermore, the first seal member 126 can be located between the connector port 104 (and the ground cone 114) and the cap portion 144 of fastener member 116. When connecting the fastener member 116 to the connector port 104, the first seal member 126 can deform and fill a space between the fastener member 116 and the connector port 104 (and the ground cone 114) to form a liquid-tight connection when the ground cone 114 is connected to an electrical conduit 202 extending through the fastener member 116.

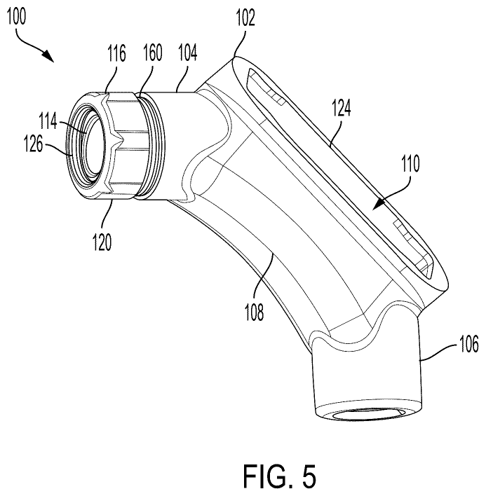

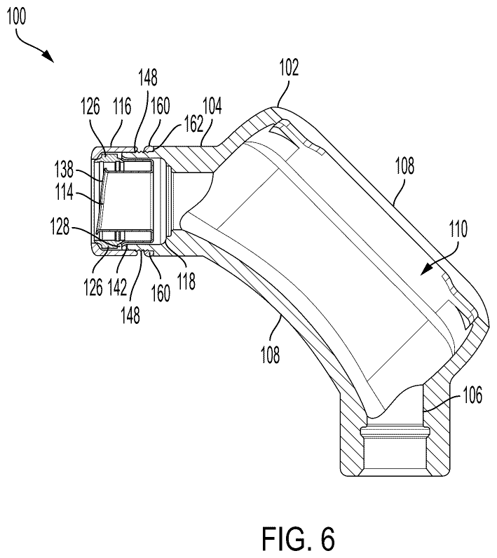

FIG. 5 is a perspective view of an example apparatus 100 of FIG. 1, according to some embodiments. FIG. 6 is a sectional side view of the apparatus 100 of FIG. 5, according to some embodiments. Unless specifically referenced, FIGS. 5 and 6 will be described collectively.

Apparatus 100 can include conduit body 102 including one or more connector ports including at least one connector port 104 defining a first channel 118 in fluid communication with interior region 110 of the conduit body 102, fastener member 116, and first seal member 126. Fastener member 116 can be configured to receive an electrical conduit 202 positioned therethrough to connect the electrical conduit 202 to connector port 104. The electrical conduit 202 can extend through fastener member 116 from the first end of body 120 and out the second end of body 120.

Apparatus 100 can include first seal member 126 located in fastener member 116 adjacent the first end of the body 120 of fastener member 116. First seal member 126 can be formed of a first elastically deformable material. The fastener member 116 can engage the connector port 104 to movably connect the fastener member 116 to the connector port 104. In some embodiments, the fastener member 116 can include one or more threads 146 formed on an inner surface of body 120 adjacent the second end and the connector port 104 can include one or more threads 148 formed on an outer surface of connector port 104, and the fastener member 116 can be connected to connector port 104 by the one or more threads 146 of the fastener member 116 engaging the corresponding one or more threads 148 of connector port 104. With the fastener member 116 engaging the connector port 104, the first seal member 126 located in the fastener member 116 can elastically deform and fill a space of a connection point to form the liquid-tight connection between electrical conduit 202 and connector port 104. In some embodiments, the first seal member 126 can fill a space between fastener member 116, connector port 104, and electrical conduit 202, so that a liquid-tight connection is formed at the connection point.

Apparatus 100 can further include ground cone 114 arranged in the first channel 118 of connector port 104, according to some embodiments. The ground cone 114 can be configured to engage electrical conduit 202 at an end thereof to connect the electrical conduit 202 to ground cone 114. In this regard, the ground cone 114 can be arranged in first channel 118 of connector port 104, and the ground cone 114 can be connected to the end of electrical conduit 202 in the first channel 118, the ground cone 114 being connected to the end of the electrical conduit 202 that extends from the fastener member 116 (e.g., from the second end of fastener member 116).

With the electrical conduit 202 extending through fastener member 116 and being connected to the ground cone 114 in the first channel 118, the fastener member 116 can be movably connected to the connector port 104 by fastener member 116 engaging the connector port 104 such that the first seal member 126 engages a portion of the ground cone 114 surrounding electrical conduit 202 to retain the ground cone 114 in the first channel 118 of connector port 104. In addition, the fastener member 116 can be movably connected to the connector port 104 with the electrical conduit 202 connected to ground cone 114 in the first channel 118 of connector port 104 such that the first seal member 126 elastically deforms and fills a space of the connection point to form a liquid-tight connection between electrical conduit 202 and the connector port 104 of conduit body 102. In some embodiments, the first seal member 126 can fill a space between ground cone 114, fastener member 116, connector port 104, and electrical conduit 202, so that a liquid-tight connection is formed at the connection point. In other embodiments, the first seal member 126 can fill a space between ground cone 114, fastener member 116, and electrical conduit 202, so that a liquid-tight connection is formed at the connection point between electrical conduit 202 and connector port 104.

Apparatus 100 can include a second seal member 160, according to some embodiments. Second seal member 160 can be formed of a second elastically deformable material. Second seal member 160 can form a circumferential body arranged around connector port 104. Second seal member 160 can be arranged around the connector port 104, and the second seal member 160 can be configured to fill a longitudinal area around connector port 104 located between fastener member 116 and conduit body 102 when the fastener member 116 is connected to connector port 104. In some embodiments, the longitudinal area can include a portion of the threads 148 on the outer surface of connector port 104 left exposed after the fastener member 116 fully engages the connector port 104 so as to form the liquid-tight connection between electrical conduit 202 and the connector port 104 and conduit body 102. In other embodiments, the longitudinal area can include a surface portion of connector port 104 located between the fastener member 116 and the conduit body 102 left exposed after the fastener member 116 fully engages the connector port 104 so as to form the liquid-tight connection between electrical conduit 202 and the connector port 104 and conduit body 102. In yet other embodiments, the longitudinal area can include a portion of the threads 148 of connector port 104 and a surface portion of connector port 104 located between fastener member 116 and the connector port 104. The second seal member 160 can be configured to fill the longitudinal area around the connector port 104 between the fastener member 116 and the conduit body 102.

The second seal member 160 can be configured to fill the longitudinal area between fastener member 116 and conduit body 102 around the connector port 104 by elastically deforming in response to the fastener member 116 engaging the second seal member 160 and applying a compressive force to the second seal member 160 as the fastener member 116 engages the connector port 104 when connecting the fastener member 116 to the connector port 104 to form a liquid-tight connection between the electrical conduit 202 and the connector port 104 of conduit body 102.

Second seal member 160 can be configured to fill the gap between fastener member 116 and conduit body 102. In some embodiments, the second seal member 160 filling the gap between fastener member 116 and conduit body 102 can include the second seal member 160 sealing the gap between fastener member 116 and conduit body 102. In addition, the second seal member 160 filling the gap between fastener member 116 and conduit body 102 can be configured to protect the outer surface of connector port 104 between fastener member 116 and conduit body 102 from exposure to liquids such as, for example, water, cleaning solution, or other contaminants. For example, the second seal member 160 can fill the space between fastener member 116 and conduit body 102 including an exposed thread portion to protect from contamination and/or bacterial growth.

In addition, conduit body 102 can further include a step 162 located between connector port 104 and conduit body 102. Second seal member 160 can be arranged around an outer circumferential surface of connector port 104 between fastener member 116 and step 162. Second seal member 160 can be configured to fill a gap between fastener member 116 and step 162. In some embodiments, second seal member 160 filling the gap between fastener member 116 and step 162 can include the second seal member 160 sealing the gap between fastener member 116 and step 162. In addition, the second seal member 160 filling the gap between fastener member 116 and step 162 can be configured to protect the outer surface of connector port 104 between fastener member 116 and step 162 of conduit body 102 from exposure to liquids such as, for example, water, cleaning solution, or other contaminants.

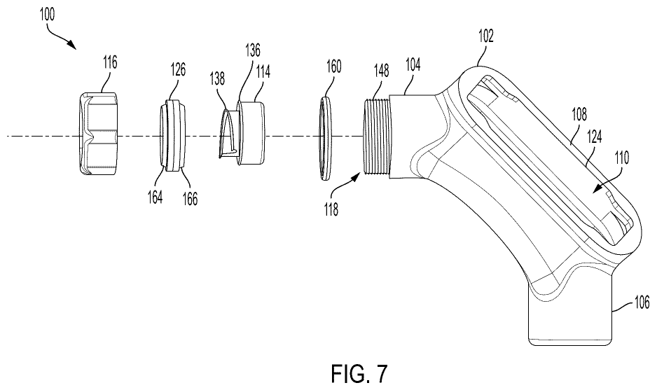

FIG. 7 is an exploded view of the apparatus 100 of FIG. 5, according to some embodiments.

Apparatus 100 can come pre-assembled including conduit body 102 having at least connector port 104, second seal member 160 arranged around connector port 104 adjacent the conduit body 102, ground cone 114 arranged in first channel 118 of connector port 104, first seal member 126 arranged in the body 120 of fastener member 116 adjacent the cap portion 144, and fastener member 116 movably engaging an end of the connector port 104.

The ground cone 114 can be positioned in first channel 118 so that the flange 136 engages the surface 128 at the end of the connector port 104. In addition, the fastener member 116 can include a threads 146 at body 120 corresponding to the threads 148 of the connector port 104, and the threads 146 of the fastener member 116 can engage the threads 148 of the connector port 104 to movably connect the fastener member 116 to the connector port 104.

Furthermore, the first seal member 126 can be located between the connector port 104 (and the ground cone 114) and the cap portion 144 of fastener member 116. When connecting the fastener member 116 to the connector port 104, the first seal member 126 can deform and fill a space between the fastener member 116 and the connector port 104 (and the ground cone 114) to form a liquid-tight connection when the ground cone 114 is connected to an electrical conduit 202 extending through the fastener member 116.

In addition, in some embodiments, the first seal member 126 can include a first wing 164 located at a first side of the first seal member 126 and a second wing 166 located at a second side of the first seal member 126 opposite the first side. In response to the fastener member 116 engaging the connector port 104, the first wing 164 can deform and fill a space between the fastener member 116 and electrical conduit 202 connected to ground cone 114 and the second wing 166 can deform and fill a space between the ground cone 114 and electrical conduit 202 so as to form the liquid-tight connection at the connector port 104. In some embodiments, the first wing 164 can fill a space between the electrical conduit 202 and an inner surface of the fastener member 116 adjacent to aperture 122, and the second wing 166 can fill a space between the electrical conduit 202 and an inner surface of the flange 136 of the first cylindrical portion 130.

In use, as the fastener member 116 is progressively tightened onto the connector port 104, the continued force exerted by cap portion 144 onto the first seal member 126 can cause radially outward displacement of the first wing 164 and second wing 166 of the first seal member 126. Thus, to prevent first seal member 126 from popping out of space between connector port 104 and fastener member 116, the first seal member 126 is sized and shaped such that compression of first seal member 126 between the cap portion 144 and the connector port 104 causes the first seal member 126 to generally deform radially inward to form the liquid-tight connection at the connector port 104.

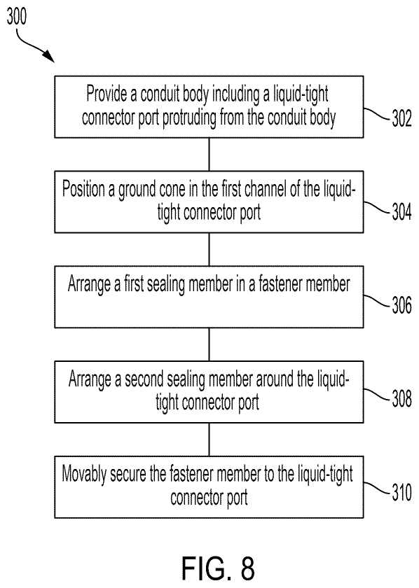

FIG. 8 is a flow diagram of a method 300 for assembling a conduit body 102 of FIG. 1, according to some embodiments.

At 302, the method 300 includes providing the conduit body including a liquid-tight connector port protruding from the conduit body. The conduit body is shown as conduit body 102 and the liquid-tight connector port is shown as connector port 104 in FIG. 5. In some embodiments, the liquid-tight connector port can have a threaded outer surface. The threaded outer surface is shown as threads 148 in FIG. 5. In some embodiments, the liquid-tight connector port can define a first channel in fluid communication with an interior region of the conduit body. The first channel is shown as first channel 118 in FIG. 5.

At 304, the method 300 includes positioning a ground cone in the first channel of the liquid-tight connector port. The ground cone is shown as ground cone 114 in FIG. 5. In some embodiments, the ground cone is configured to engage a liquid-tight conduit. In some embodiments, the ground cone is configured to engage the liquid-tight conduit to provide an electrical conduit connected to the grounding cone with electrical grounding protection.

At 306, the method 300 includes arranging a first seal member in a fastener member. The first seal member is shown as first seal member 126 and the fastener member is shown as fastener member 116 in FIG. 5. In some embodiments, the fastener member includes a threaded inner surface. In some embodiments, the fastener member is configured to engage the liquid-tight connector port by threading the threaded inner surface of the fastener member to the threaded outer surface of the liquid-tight connector port. The threaded inner surface is shown as threads 146 in FIG. 5.

At 308, the method 300 includes arranging a second seal member around a portion of the threaded outer surface of the liquid-tight connector port adjacent the conduit body. The second seal member is shown as second seal member 160 in FIG. 5. In some embodiments, the second seal member can be arranged around the liquid-tight connector port between the fastener member and the conduit body adjacent a step. The step is shown as 162// in FIG. 5.

At 310, the method 300 includes engaging the threaded outer surface of the liquid-tight connector port with the threaded inner surface of the fastener member to movably secure the fastener member to the liquid-tight connector port. In some embodiments, movably securing the fastener member to the liquid-tight connector port can cause the second seal member to deform and fill a space between the fastener member and the liquid body at a remaining portion of the threaded outer surface of the liquid-tight connector port that is not engaged by the fastener member. In addition, in some embodiments, when an electrical conductor is positioned so as to extend through the fastener member and is connected to the ground cone arranged in the channel of the liquid-tight connector port, movably securing the fastener member to the liquid-tight connector port can cause the first seal member to deform and fill a space defined by the liquid-tight connector port, the fastener member, the ground cone, the electrical conductor, or any combination thereof, so as to form a liquid-tight connection at the liquid-tight connector port.

First seal member 126 can be made from a first elastically deformable material, and second seal member 160 can be made from a second elastically deformable material. In some embodiments, first seal member 126 and second seal member 160 can be made from similar materials. In other embodiments, first seal member 126 and second seal member 160 can be made from different materials.

First seal member 126 and second seal member 160 may each be made from a plastic material or a rubber material. Plastic materials can include polymer material, thermoplastic material, or other like materials. Non-limiting examples of plastic materials suitable for use as first seal member 126, second seal member 160, or both the first seal member 126 and the second seal member 160 can include, but is not limited to, polypropylene (PP), high-density polyethylene (HDPE), and polyamide (i.e., nylon). Non-limiting examples of thermoplastic materials for use as first seal member 126, second seal member 160, or both the first seal member 126 and the second seal member 160 can include, but is not limited to, thermoplastic elastomers (TPE), such as, for example, thermoplastic vulcanizates (TPV), thermoplastic polyurethanes (TPU), thermoplastic co-polyesters (TPC), or styrenic block copolymers (SBC). Non-limiting examples of rubber materials for use as first seal member 126, second seal member 160, or both the first seal member 126 and the second seal member 160 can include, but is not limited to, styrene butadiene rubber (SBS), ethylene propylene rubber (EPR), chloroprene rubber (CR), nitrile rubber (NBR), natural rubber, butyl rubber, polyurethane (PU), or any combination thereof.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “tapered threads” refers to threads formed on a member that taper along their profile, decreasing in diameter as you move down the thread towards an end of the member.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” The recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be: disposed directly between both of the two other structural elements such that the particular structural component is in direct contact with both of the two other structural elements; disposed directly next to only one of the two other structural elements such that the particular structural component is in direct contact with only one of the two other structural elements; disposed indirectly next to only one of the two other structural elements such that the particular structural component is not in direct contact with only one of the two other structural elements, and there is another element which juxtaposes the particular structural component and the one of the two other structural elements; disposed indirectly between both of the two other structural elements such that the particular structural component is not in direct contact with both of the two other structural elements, and other features can be disposed therebetween; or any combination(s) thereof.

### Aspects

Various Aspects are described below. It is to be understood that any one or more of the features recited in the following Aspect(s) can be combined with any one or more other Aspect(s).

Aspect 1. A conduit device comprising: a connector port protruding from a conduit body, the connector port comprising: a first channel in fluid communication with an interior region of the conduit body; a fastener member comprising a body and a cylindrical channel extending therethrough, the fastener member configured to engage the connector port to movably secure to the connector port; and a first seal member circumferentially arranged in the cylindrical channel of the fastener member; wherein the connector port being configured to form a liquid-tight connection with a liquid-tight flexible conduit by positioning the liquid-tight flexible conduit so as to axially extend through the cylindrical channel of the body of the fastener member and connecting an end of the liquid-tight flexible conduit extending from the fastener member to the connector port in the first channel, and wherein the first seal member being configured to fill a space between the fastener member, the connector port, and the liquid-tight flexible conduit, to retain the liquid-tight flexible conduit in the first channel in response to the fastener member engaging the connector port.

Aspect 2. The conduit device of aspect 1, further comprising: a ground cone arranged in the first channel of the conduit body, wherein the liquid-tight flexible conduit extending from the fastener member being connected to the connector port in the first channel comprises the liquid-tight flexible conduit connecting to the ground cone in the first channel.

Aspect 3. The conduit device of aspect 2, wherein the ground cone comprising: a first cylindrical portion comprising: a flange configured to engage an end of the connector port; and a second cylindrical portion comprising: a helical flange configured to engage the liquid-tight flexible conduit, and a second channel configured to be in fluid communication with the interior region of the conduit body in response to the ground cone being arranged in the first channel; wherein an inner diameter of the first cylindrical portion is greater than an outer diameter of the second cylindrical portion.

Aspect 4. The conduit device of aspects 2 or 3, wherein the ground cone comprises the first cylindrical portion continuously formed with the second cylindrical portion and defining a gap between an inner surface of the first cylindrical portion and an outer surface of the second cylindrical portion; and wherein the liquid-tight flexible conduit is positioned in the gap between the first cylindrical portion and the second cylindrical portion when the helical flange of the ground cone engages a helical groove formed on an inner surface of the liquid-tight flexible conduit to connect the liquid-tight flexible conduit to the connector port.

Aspect 5. The conduit device of aspects 2, 3, or 4, wherein the connector port further comprises: a chamfer located between an inner surface and an outer surface of the connector port, wherein the flange of the ground cone being configured to engage the connector port at the chamfer.

Aspect 6. The conduit device according to any of the preceding aspects, wherein the connector port further comprising one or more threads formed on an outer surface of the connector port, and wherein the fastener member further comprising one or more threads formed on an inner surface of the cylindrical channel of the body adjacent a second end, the one or more threads of the fastener member configured to engage the one or more threads of the connector port to movably secure the fastener member to the connector port.

Aspect 7. The conduit device according to any of the preceding aspects, further comprising: a second seal member circumferentially arranged around the connector port, wherein the second seal member fills a longitudinal area between the fastener member and the conduit body when the fastener member is connected to the connector port.

Aspect 8. The conduit device of aspect 7, wherein the first seal member is formed of a first elastically deformable material; and wherein the second seal member is formed of a second elastically deformable material.

Aspect 9. The conduit device of aspects 7 of 8, wherein the first seal member and the second seal member are formed of a same elastically deformable material.

Aspect 10. The conduit device according to any of the preceding aspects, wherein the conduit body is a junction box configured to accommodate one or more electrical conductors.

Aspect 11. The conduit device according to any of the preceding aspects, wherein the conduit body is an outlet box configured to receive one or more electrical components including an electrical outlet device and one or more electrical conductors.

Aspect 12. The conduit device according to any of the preceding aspects, wherein the conduit body comprises: a plurality of connector ports, wherein at least one connector port of the plurality of connector ports comprises the connector port.

Aspect 13. An apparatus comprising: a conduit body comprising one or more connector ports protruding from the conduit body in fluid communication with an interior region of the conduit body, at least one connector port of the one or more connector ports comprising a liquid-tight connector port comprising: a first channel, and one or more threads formed on an outer surface of the liquid-tight connector port; a gland nut comprising: a body, a cylindrical channel extending through the body, and one or more threads formed on an inner surface of the cylindrical channel, the one or more threads of the cylindrical channel of the body being configured to engage the one or more threads of the liquid-tight connector port to movably secure the gland nut to the liquid-tight connector port; and a first seal member circumferentially arranged in the cylindrical channel of the gland nut, the first seal member formed of a first elastically deformable material; wherein the liquid-tight connector port being configured to form a liquid-tight connection with a liquid-tight flexible conduit by positioning the liquid-tight flexible conduit so as to axially extend through the cylindrical channel of the body of the gland nut and connecting an end of the liquid-tight flexible conduit extending from the gland nut to the liquid-tight connector port in the first channel, and wherein the first seal member filling a space between the gland nut, the liquid-tight connector port, and the liquid-tight flexible conduit, to retain the liquid-tight flexible conduit in the first channel in response to the gland nut engaging the liquid-tight connector port.

Aspect 14. The apparatus of aspect 13, further comprising: a ground cone arranged in the first channel of the conduit body, the ground cone comprising: a first cylindrical portion comprising: a flange configured to engage an end of the liquid-tight connector port; and a second cylindrical portion comprising: a helical flange configured to engage a helical groove formed on an inner surface of the liquid-tight flexible conduit, and a second channel configured to be in fluid communication with the interior region of the conduit body in response to the ground cone being arranged in the first channel; wherein an inner diameter of the first cylindrical portion is greater than an outer diameter of the second cylindrical portion, and the first cylindrical portion being continuously formed with the second cylindrical portion and defining a gap between an inner surface of the first cylindrical portion and an outer surface of the second cylindrical portion; wherein the liquid-tight flexible conduit extending from the gland nut being connected to the liquid-tight connector port in the first channel comprises the liquid-tight flexible conduit being positioned in the gap between the first cylindrical portion and the second cylindrical portion when the helical groove engages the helical groove formed on an inner surface of the liquid-tight flexible conduit to connect the liquid-tight flexible conduit to the liquid-tight connector port.

Aspect 15. The apparatus of aspect 14, wherein the liquid-tight connector port further comprises: a chamfer located between an inner surface and an outer surface of the liquid-tight connector port, wherein the flange of the ground cone being configured to engage the liquid-tight connector port at the chamfer.

Aspect 16. The apparatus of aspects 13, 14, or 15, further comprising: a second seal member circumferentially arranged around the liquid-tight connector port, the second seal member formed of a second elastically deformable material, wherein the second seal member fills a longitudinal area between the gland nut and the conduit body when the gland nut is connected to the liquid-tight connector port.

Aspect 17. The apparatus of aspect 16, wherein the first seal member and the second seal member are formed of a same elastically deformable material.

Aspect 18. The apparatus of aspects 13, 14, 15, 16, or 17, wherein the conduit body is a junction box configured to accommodate one or more electrical conductors.

Aspect 19. The apparatus of aspects 13, 14, 15, 16, 17, or 18, wherein the conduit body is an outlet box configured to receive one or more electrical components including an electrical outlet device and one or more electrical conductors.

Aspect 20. A method for assembling a conduit body, the method comprising: providing the conduit body comprising a liquid-tight connector port protruding from the conduit body, the liquid-tight connector port defining a first channel in fluid communication with an interior region of the conduit body, and an outer surface of the liquid-tight connector port having one or more threads formed thereon; positioning a ground cone in the first channel of the liquid-tight connector port; arranging a first seal member in a fastener member, the fastener member comprising a body including a cylindrical channel extending therethrough, and an inner surface of the cylindrical channel of the body having one or more threads formed thereon; arranging a second seal member around the liquid-tight connector port; and movably securing the fastener member to the liquid-tight connector port.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A conduit device comprising:
a connector port protruding from a conduit body, the connector port comprising:
a first channel in fluid communication with an interior region of the conduit body;
a fastener member comprising a body and a cylindrical channel extending therethrough, the fastener member configured to engage the connector port to movably secure to the connector port; and
a first seal member circumferentially arranged in the cylindrical channel of the fastener member;
wherein the connector port being configured to form a liquid-tight connection with a liquid-tight flexible conduit by positioning the liquid-tight flexible conduit so as to axially extend through the cylindrical channel of the body of the fastener member and connecting an end of the liquid-tight flexible conduit extending from the fastener member to the connector port in the first channel, and wherein the first seal member being configured to fill a space between the fastener member, the connector port, and the liquid-tight flexible conduit, to retain the liquid-tight flexible conduit in the first channel in response to the fastener member engaging the connector port.

2. The conduit device of claim 1, further comprising:
a ground cone arranged in the first channel of the conduit body,
wherein the liquid-tight flexible conduit extending from the fastener member being connected to the connector port in the first channel comprises the liquid-tight flexible conduit connecting to the ground cone in the first channel.

3. The conduit device of claim 2, wherein the ground cone comprising:
a first cylindrical portion comprising:
a flange configured to engage an end of the connector port; and
a second cylindrical portion comprising:
a helical flange configured to engage the liquid-tight flexible conduit, and
a second channel configured to be in fluid communication with the interior region of the conduit body in response to the ground cone being arranged in the first channel;
wherein an inner diameter of the first cylindrical portion is greater than an outer diameter of the second cylindrical portion.

4. The conduit device of claim 3, wherein the ground cone comprises the first cylindrical portion continuously formed with the second cylindrical portion and defining a gap between an inner surface of the first cylindrical portion and an outer surface of the second cylindrical portion; and
wherein the liquid-tight flexible conduit is positioned in the gap between the first cylindrical portion and the second cylindrical portion when the helical flange of the ground cone engages a helical groove formed on an inner surface of the liquid-tight flexible conduit to connect the liquid-tight flexible conduit to the connector port.

5. The conduit device of claim 3, wherein the connector port further comprises:
a chamfer located between an inner surface and an outer surface of the connector port,
wherein the flange of the ground cone being configured to engage the connector port at the chamfer.

6. The conduit device of claim 1, wherein the connector port further comprising one or more threads formed on an outer surface of the connector port, and wherein the fastener member further comprising one or more threads formed on an inner surface of the cylindrical channel of the body adjacent a second end, the one or more threads of the fastener member configured to engage the one or more threads of the connector port to movably secure the fastener member to the connector port.

7. The conduit device of claim 1, further comprising:
a second seal member circumferentially arranged around the connector port, wherein the second seal member fills a longitudinal area between the fastener member and the conduit body when the fastener member is connected to the connector port.

8. The conduit device of claim 7, wherein the first seal member is formed of a first elastically deformable material; and
wherein the second seal member is formed of a second elastically deformable material.

9. The conduit device of claim 8, wherein the first seal member and the second seal member are formed of a same elastically deformable material.

10. The conduit device of claim 1, wherein the conduit body is a junction box configured to accommodate one or more electrical conductors.

11. The conduit device of claim 1, wherein the conduit body is an outlet box configured to receive one or more electrical components including an electrical outlet device and one or more electrical conductors.

12. The conduit device of claim 1, wherein the conduit body comprises:
a plurality of connector ports,
wherein at least one connector port of the plurality of connector ports comprises the connector port.

13. An apparatus comprising:
a conduit body comprising one or more connector ports protruding from the conduit body in fluid communication with an interior region of the conduit body, at least one connector port of the one or more connector ports comprising a liquid-tight connector port comprising:
a first channel, and
one or more threads formed on an outer surface of the liquid-tight connector port;
a gland nut comprising:
a body,
a cylindrical channel extending through the body, and
one or more threads formed on an inner surface of the cylindrical channel, the one or more threads of the cylindrical channel of the body being
configured to engage the one or more threads of the liquid-tight connector port to movably secure the gland nut to the liquid-tight connector port; and
a first seal member circumferentially arranged in the cylindrical channel of the gland nut, the first seal member formed of a first elastically deformable material; wherein the liquid-tight connector port being configured to form a liquid-tight connection with a liquid-tight flexible conduit by positioning the liquid-tight flexible conduit so as to axially extend through the cylindrical channel of the body of the gland nut and connecting an end of the liquid-tight flexible conduit extending from the gland nut to the liquid-tight connector port in the first channel, and wherein the first seal member filling a space between the gland nut, the liquid-tight connector port, and the liquid-tight flexible conduit, to retain the liquid-tight flexible conduit in the first channel in response to the gland nut engaging the liquid-tight connector port.

14. The apparatus of claim 13, further comprising:
a ground cone arranged in the first channel of the conduit body, the ground cone comprising:
a first cylindrical portion comprising:
a flange configured to engage an end of the liquid-tight connector port; and
a second cylindrical portion comprising:
a helical flange configured to engage a helical groove formed on an inner surface of the liquid-tight flexible conduit, and
a second channel configured to be in fluid communication with the interior region of the conduit body in response to the ground cone being arranged in the first channel;
wherein an inner diameter of the first cylindrical portion is greater than an outer diameter of the second cylindrical portion, and the first cylindrical portion being continuously formed with the second cylindrical portion and defining a gap between an inner surface of the first cylindrical portion and an outer surface of the second cylindrical portion;
wherein the liquid-tight flexible conduit extending from the gland nut being connected to the liquid-tight connector port in the first channel comprises the liquid-tight flexible conduit being positioned in the gap between the first cylindrical portion and the second cylindrical portion when the helical groove engages the helical groove formed on an inner surface of the liquid-tight flexible conduit to connect the liquid-tight flexible conduit to the liquid-tight connector port.

15. The apparatus of claim 14, wherein the liquid-tight connector port further comprises:
a chamfer located between an inner surface and an outer surface of the liquid-tight connector port,
wherein the flange of the ground cone being configured to engage the liquid-tight connector port at the chamfer.

16. The apparatus of claim 14, further comprising:
a second seal member circumferentially arranged around the liquid-tight connector port, the second seal member formed of a second elastically deformable material,
wherein the second seal member fills a longitudinal area between the gland nut and the conduit body when the gland nut is connected to the liquid-tight connector port.

17. The apparatus of claim 16, wherein the first seal member and the second seal member are formed of a same elastically deformable material.

18. The apparatus of claim 14, wherein the conduit body is a junction box configured to accommodate one or more electrical conductors.

19. The apparatus of claim 14, wherein the conduit body is an outlet box configured to receive one or more electrical components including an electrical outlet device and one or more electrical conductors.

20. A method for assembling a conduit body, the method comprising:
providing the conduit body comprising a liquid-tight connector port protruding from the conduit body, the liquid-tight connector port defining a first channel in fluid communication with an interior region of the conduit body, and an outer surface of the liquid-tight connector port having one or more threads formed thereon;
positioning a ground cone in the first channel of the liquid-tight connector port;
arranging a first seal member in a fastener member, the fastener member comprising a body including a cylindrical channel extending therethrough, and an inner surface of the cylindrical channel of the body having one or more threads formed thereon;
arranging a second seal member around the liquid-tight connector port; and
movably securing the fastener member to the liquid-tight connector port.
